(19) United States
(12) Patent Application Publication
(10) Pub. No.: US 2026/0086719 A1
(43) Pub. Date: Mar. 26, 2026

(54) APPARATUS AND METHOD FOR IMPROVING COMPATIBILITY OF COMPUTER-MEMORY LINK-BASED DEVICE

(71) Applicant: SK hynix Inc., Gyeonggi-do (KR)

(72) Inventor: Deok Cheol SHIN, Gyeonggi-do (KR)

(21) Appl. No.: 19/056,744

(22) Filed: Feb. 19, 2025

(30) Foreign Application Priority Data
Sep. 25, 2024 (KR) 10-2024-0129833

(51) Int. Cl. G06F 3/06

(52) U.S. Cl. CPC G06F 3/0613; G06F 3/0659; G06F 3/0673

(57) ABSTRACT

A memory system includes at least one memory device and a controller. The controller performs data communication with at least one external device via a computer-memory link-based interface and transfers, to the at least one memory device, an input/output request received from the at least one external device. The controller is configured to check a first interface version of a first external device among the at least one external device, write, into a firmware binary, a setting value for changing a controller register configuration according to the first interface version, and process a request received from the first external device based on the firmware binary.

### CROSS-REFERENCE TO RELATED APPLICATIONS

This patent application claims the benefit of priority under 35 U.S.C. § 119 (a) to Korean Patent Application No. 10-2024-0129833, filed on Sep. 25, 2024, the entire disclosure of which is incorporated herein by reference.

### TECHNICAL FIELD

Various embodiments of the present disclosure described herein relate to a memory system, and more particularly, to a memory system including a memory expansion device or a shared memory device, which is coupled to at least one host.

### BACKGROUND

Computing systems are increasing an amount of computation in response to user needs. As the amount of computation increases, an amount of data generated or stored is also increasing. While the amount of data is increasing, a storage space available to store data in computing systems is limited. A memory expander or a shared memory device can be used to store significant amounts of data and avoid degradation of computational power and performance of the computing systems. The memory expander or the shared memory device may be understood as a composable infrastructure to overcome resource limitations of the computing systems. When the computing systems and storage expandable devices perform high-speed data communication, a system may support computation of highly integrated workloads arising from big data and machine learning. The memory system may transmit a response to a request, input along with a limited operation time during data communication with a host, within a preset time.

### BRIEF DESCRIPTION OF THE DRAWINGS

The description herein makes reference to the accompanying drawings wherein like reference numerals refer to like parts throughout the figures.

FIG. 1 is a diagram illustrating a configuration of a data processing apparatus in accordance with an embodiment of the present disclosure.

FIG. 2 is a diagram illustrating a configuration of a memory system in accordance with an embodiment of the present disclosure.

FIG. 3 is a diagram for describing a difference in register configurations within a memory system according to another embodiment of the present disclosure.

FIG. 4 is a diagram for describing a first register configuration within the memory system.

FIG. 5 is a diagram for describing a second register configuration within the memory system.

FIG. 6 is a sequence diagram for describing a first Link Training State Machine (LTSSM) operation according to an embodiment of the present disclosure.

FIG. 7 is a flowchart for describing a second LTSSM operation according to an embodiment of the present disclosure.

FIG. 8 is a flowchart for describing an operation for register configuration of a memory system according to an embodiment of the present disclosure.

FIG. 9 is a diagram illustrating a configuration of a data processing apparatus according to an embodiment of the present disclosure.

FIG. 10 is a diagram illustrating a configuration of a computer-memory link-based switch according to an embodiment of the present disclosure.

### DETAILED DESCRIPTION

Various embodiments of the present disclosure are described below with reference to the accompanying drawings. In this disclosure, elements and features may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim do not foreclose the apparatus from including additional components e.g., an interface unit, circuitry, etc.

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational, e.g., is not turned on nor activated. Examples of block/unit/circuit/component used with the “configured to” language include hardware, circuits, memory storing program instructions executable to implement the operation, etc. Additionally, “configured to” can include a generic structure, e.g., generic circuitry, that is manipulated by software and/or firmware, e.g., an FPGA or a general-purpose processor executing software to operate in a manner that is capable of performing the task(s) at issue. “Configured to” may also include adapting a manufacturing process, e.g., a semiconductor fabrication facility, to fabricate devices, e.g., integrated circuits that are adapted to implement or perform one or more tasks.

As used in this disclosure, the term ‘machine,’ ‘circuitry’ or ‘logic’ refers to all of the following: (a) hardware-only circuit implementations such as implementations in only analog and/or digital circuitry and (b) combinations of circuits and software and/or firmware, such as (as applicable): (i) to a combination of processor(s) or (ii) to portions of processor(s)/software including digital signal processor(s), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘machine,’ ‘circuitry’ or ‘logic’ applies to all uses of this term in this application, including in any claims. As a further example, as used in this application, the term ‘machine,’ ‘circuitry’ or ‘logic’ also covers an implementation of merely a processor or multiple processors or a portion of a processor and its (or their) accompanying software and/or firmware. The term ‘machine,’ ‘circuitry’ or ‘logic’ also covers, for example, and if applicable to a particular claim element, an integrated circuit for a storage device.

As used herein, the terms ‘first,’ ‘second,’ ‘third,’ and so on are used as labels for nouns that they precede, and do not imply any type of ordering, e.g., spatial, temporal, logical, etc. The terms ‘first’ and ‘second’ do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term ‘based on’ is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

Embodiments of the present disclosure can provide an apparatus and a method capable of improving the performance of a data processing apparatus including a host and a memory expansion device.

An embodiment of the present disclosure can provide a method and device capable of setting a register configuration corresponding to a version of a host when the versions of an interface for data communication between a memory system and a host are different.

Further, an embodiment of the present disclosure can provide a method and device capable of improving the compatibility of a memory system through a register configuration capable of supporting data communication with a plurality of hosts even when the plurality of hosts use interfaces of different versions.

In an embodiment of the present disclosure, a memory system can include at least one memory device; and a controller configured to perform data communication with at least one external device via a computer-memory link-based interface and transfer, to the at least one memory device, an input/output request received from the at least one external device. The controller can be configured to check a first interface version of a first external device among the at least one external device; write, into a firmware binary, a setting value for changing a controller register configuration according to the first interface version; and process a request received from the first external device based on the firmware binary.

The controller can be further configured to perform a Link Training and Status State Machine (LTSSM) operation for configurating controller registers in response to an active state request received from the first external device.

The controller can be configured to check the first interface version of the first external device during the LTSSM operation; determine whether the first interface version of the first external device and the controller register configuration are compatible; and perform data object exchange (DOE) with the first external device based on the setting value according to a compatibility to store a result of the DOE in the firmware binary.

The controller can be configured to transmit, to the at least one external device, the setting value set before the LTSSM operation is performed, when the at least one external device transmits a read request for the controller register configuration during the LTSSM operation.

The controller can be configured to perform a Link Training and Status State Machine (LTSSM) operation for performing the data communication, when a link request according to an Active Link Management Protocol (ALMP) handshake is received from the at least one external device.

The controller, operatively engaged with a memory including an extended area available for a register configuration, can be configured to set, as a default value, the controller register configuration corresponding to the first interface version of the first external device when the first interface version of the first external device is older than a version corresponding to the predetermined controller register configuration.

The at least one external device can further include a second external device having a second interface version different from the first interface version of the first external device. The controller can be configured to write into the firmware binary a setting value for changing the controller register configuration according to the second interface version of the second external device; and process a request by referring to at least some of values stored in the firmware binary depending on whether the request is received from either the first external device or the second external device.

The controller can be configured to add a first controller register configuration, corresponding to a recent interface version among the first and second interface versions of the first and second external devices, into an extended area storing a second controller register configuration corresponding to an older interface version among the first and second interface versions of the first and second external devices.

The controller can be configured to store the firmware binary in a non-volatile memory operatively engaged with the controller.

In another embodiment of the present disclosure, a computer-memory link-based apparatus can include a controller coupled to each of at least one host and at least one memory device. The controller can include a processor configured to transfer an input/output request received from the at least one host to the at least one memory device and a memory configured to store a firmware binary. The controller can be configured to check a first interface version of a first external device among the at least one external device; write, into a firmware binary, a setting value for changing a controller register configuration according to the first interface version; and process a request received from the first external device based on the firmware binary.

The controller can be configured to perform a Link Training and Status State Machine (LTSSM) operation for the controller register configuration in response to an active state request received from the first external device. The LTSSM operation can include a first operation for determining a data communication speed with the first host; and a second operation for determining the controller register configuration.

The controller can be configured to check the first interface version of the first external device during the LTSSM operation; determine whether the first interface version of the first external device and the controller register configuration are compatible; and perform data object exchange (DOE) with the first external device based on the setting value according to a compatibility to store a result of the DOE in the firmware binary.

The controller can be configured to transmit, to the at least one external device, the setting value set before the LTSSM operation is performed, when the at least one external device transmits a read request for the controller register configuration during the LTSSM operation.

The controller can be configured to store the firmware binary in a non-volatile memory operatively engaged with the controller.

In another embodiment of the present disclosure, a method for operating a system can include performing a register configuration based on a firmware binary after power is supplied; performing a Link Training and Status State Machine (LTSSM) operation in response to an active state request received from an external device; checking an interface version of the external device; determining whether the interface version of the external device and the register configuration are compatible; performing a Data Object Exchange (DOE) with the external device for a setting value based on a compatibility; and updating the setting value and storing an updated setting value in the firmware binary.

The performing the LTSSM operation can include performing a first operation for determining a data communication speed with the external device; and performing a second operation for determining the register configuration.

The method can further include transmitting, to the external device, the setting value set before the LTSSM operation is performed, in response to a read request for the register configuration, transmitted from the external device, during the LTSSM operation.

The method can further include performing a Link Training and Status State Machine (LTSSM) operation for performing data communication, in response to a link request according to an Active Link Management Protocol (ALMP) handshake, received from the external device.

The updating the setting values can include setting a register configuration corresponding to the interface version of the external device as a default value, in response to the first interface version of the external device, which is older than a version previously stored in the firmware binary; and adding a register configuration, corresponding to the version previously stored in the firmware binary, in an extended area.

The method can further include storing firmware binary in a non-volatile memory.

These and other features and advantages of the invention will become apparent from the detailed description and the accompanying drawings of embodiments of the present disclosure. Embodiments will now be described with reference to the accompanying drawings, wherein like numbers reference like elements.

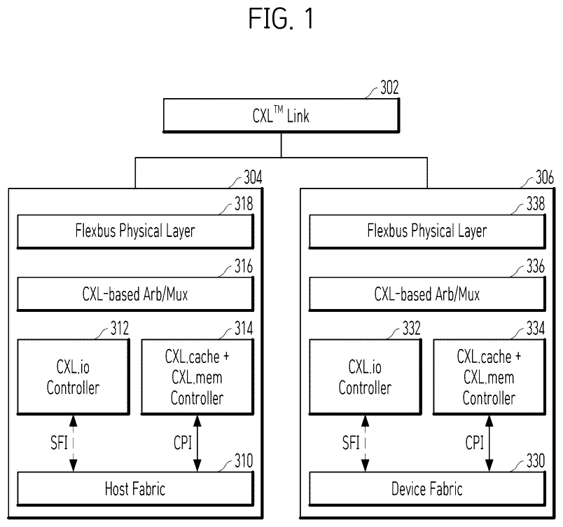

FIG. 1 is a diagram illustrating a configuration of a data processing apparatus in accordance with an embodiment of the present disclosure.

Referring to FIG. 1, the data processing device can include a host 304 and a memory system 306 which can be coupled to each other via a computer-memory communication link (e.g., CXL™ link) 302.

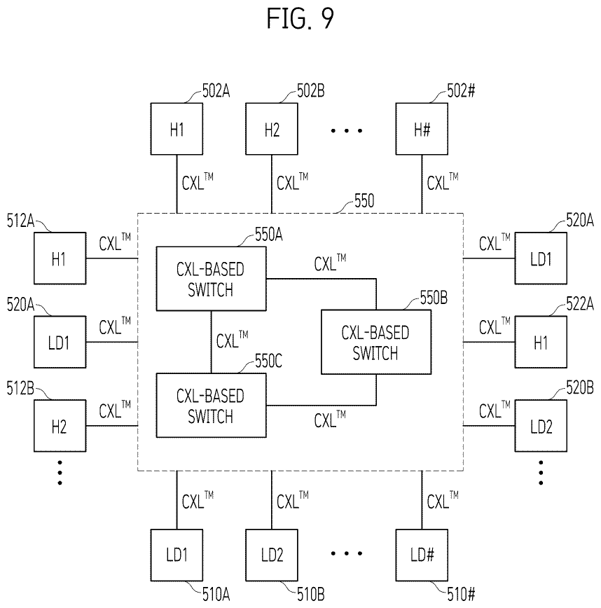

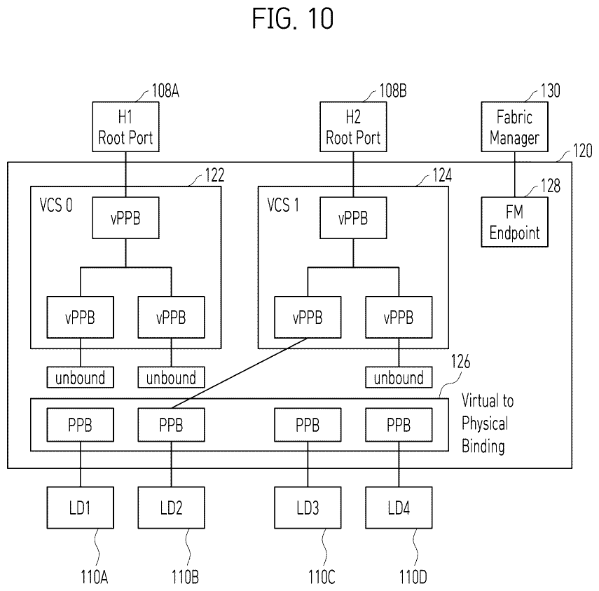

The computer-memory communication link 302 can support transmission and reception of data or signals via a preset interface or protocol (e.g., a CXL-based interface, a CXL-based protocol). According to an embodiment, the computer-memory communication link 302 can be a means for directly coupling the host 304 and the memory system 306. In another embodiment, the computer-memory communication link 302 can include a connection device 550 or a link-based switch (e.g., a CXL-based switch 120) described in FIGS. 9 and 10.

According to an embodiment, the host 304 can include an agent supporting a host fabric 310 and the CXL-based interface. Further, the memory system 306 can include an agent supporting a device fabric 330 and the CXL-based interface. Herein, the agent that could be included in the host 304 and the memory system 306 can include a system-on-chip (SoC) circuit (e.g., a semiconductor IP circuit/block) that is coupled to a fabric. For example, one side of devices that perform data communication with the CXL-based interface or the CXL-based protocol can include the agent, and the other side can include the fabric.

According to an embodiment, an interface for agent-to-fabric (A2F) coupling can include a global channel used for supporting a set of consistent interconnection protocols and communicating control signals for supporting the interface, a request channel used for communicating a message related to a request to other agents in the fabric, a response channel used for communicating a response to other agents in the fabric, and a data channel used for communicating a message related to data transfer to other agents in the fabric. Here, the data transfer can include payload data. For example, for upstream ports, the Agent-to-Fabric (A2F) can correspond to Host-to-Device (e.g., host-to-memory system) (H2D) of CXL-based data communication and the Fabric-to-Agent (F2A) can correspond to Device-to-Host (D2H) of the CXL-based data communication. For downstream ports, the A2F can correspond to the D2H and the F2A can correspond to the H2D. Also, for the upstream ports, the A2F can correspond to a Request with Data (RwD) from a master to a slave (M2S) supported by the CXL-based interface, while the F2A can correspond to a data response (DRS) from the slave to the master (S2M) supported by the CXL-based interface. For downstream ports, the A2F can correspond to a data response (DRS) from the slave to the master (S2M), while the F2A can correspond to a Request with Data (RwD) from the master to the slave (M2S).

Each of the host 304 and the memory system 306 supporting transmission and reception of data or signals via the CXL-based interface or the CXL-based protocol can include a Flex Bus physical layer 318, 338. When components within the data processing apparatus utilize Flex Bus ports, the host 304 and the memory system 306 can be designed to provide a choice of providing either a native PCIe protocol or a CXL™ protocol over a high-bandwidth, off-package link. The choice can be made during a link training via alternate protocol negotiation. The choice can vary based on a device plugged into a slot. Because the Flex Bus uses a PCIe electrical device, the Flex Bus can be compatible with a PCIe re-timer and form factors that support the PCIe protocol.

In addition, each of the host 304 and the memory system 306 supporting the transmission and reception of data or signals through the CXL-based interface or the CXL-based protocol can include an arbitrator and multiplexer (CXL Arb/Mux) 316, 336 as a component to facilitate the use of a PCIe physical layer. The arbitrator and multiplexer 316, 336 can dynamically multiplex data coming from various protocols (e.g., CXL.IO, CXL.Cache-Mem, etc.) and route the data to the Flex Bus physical layer 318, 338. This scheme can be useful for switching and utilizing various functions supported by the CXL-based interface or the CXL-based protocol without making many updates in a physical layer which is one of the most complex components to be designed.

Each of the host 304 and the memory system 306 supporting the transmission and reception of data or signals through the CXL-based interface or the CXL-based protocol can include at least one protocol controller. According to an embodiment, the host 304 can include an input/output (I/O) controller 312 and a cache and memory controller 314, and the memory system 306 can include an input/output (I/O) controller 332 and a cache and memory controller 334.

For example, an input/output (I/O) protocol (CXL.io) can be a PCIe-based non-coherent I/O protocol including enhanced features for supporting an accelerator. The I/O protocol (CXL.io) can provide a non-coherent load/store interface to an input/output (I/O) device. The I/O controllers 312, 332 can have a layered structure including a CXL.io transaction layer and a CXL.io link layer. The CXL.io transaction layer within the I/O controller 332 can control flows of signals and data in response to transaction types, transaction packet formatting, credit-based flow control, virtual channel management, and/or transaction ordering rules. Further, the CXL.io link layer can act as an intermediate step between the CXL.io transaction layer and the Flex Bus physical layer 318, 338. The CXL.io link layer can provide a mechanism for reliably exchanging transaction layer packets (TLPs) between two components on the computer-memory communication link 302. The PCIe data link layer can be utilized as the CXL.io link layer.

The I/O controllers 312, 332 can communicate with the fabric, using a system firmware interface (SFI). The system firmware interface (SFI) can be an interface that is configured to manage an interaction between a system firmware and a CXL-based device. The SFI can support initialization, configuration, and management tasks of the host 304 or the memory system 306. For example, the SFI can be responsible for initializing and configuring the CXL-based device upon booting of the host 304 or the memory system 306. Further, the SFI can be configured to support functions for monitoring the status of the host 304 or the memory system 306 and allocating resources as needed. In addition, the SFI can use a protocol which could be designed or defined to support communication between a device for the CXL-based interface and the system firmware. The SFI can enable the device for the CXL-based interface to be integrated with another component of a system such as the memory system 306 and the host 304.

The cache and memory controller 314, 334 can control flows of signals and data based on two protocols. For example, a cache protocol (CXL.cache) can be an agent coherence protocol that supports device caching of host memory. According to an embodiment, the cache and memory controller 314, 334 can have a layered structure including a transaction layer and a link layer for controlling the flows of signals and data based on the two protocols.

The cache protocol (CXL.cache) can be configured to support or define multiple requests, each with at least one associated response message and sometimes data transfer, for the interaction between the memory system 306 and the host 304. The CXL-based interface can include three channels, each channel for requests, responses, and data individually, in each direction between the memory system 306 and the host 304. The channels are named according to their direction, e.g., device-to-host (D2H) for the memory system 306 to the host 304 and host-to-device (H2D) for the host 304 to the memory system 306. The channels can carry requests, responses, and data, which are a type of transactions being carried between the memory system 306 and the host 304. According to an embodiment, the separate channels can support the use of dedicated wires for different types of messages. The separate channels can allow for both decoupling per wire and higher effective throughput.

The memory management protocol (CXL.mem) can be a memory access protocol that is designed or configured to support a memory coupled to the memory system 306. Broadly, the memory management protocol (CXL.mem) might be understood as a transactional interface between two devices such as the host 304 and the memory system 306. The physical layer and link layer of the CXL-based interface can also be used when communicating between memory dies. The memory management protocol (CXL.mem) can be used for various memory configurations, such as a configuration where a memory controller for controlling a memory device is located in the host 304, a configuration where the memory controller is located in an accelerator device or the memory system 306, or a configuration where the memory controller is included in a memory buffer chip. The memory management protocol (CXL.mem) can also be applied to various memory types and configurations (e.g., flat, hierarchical, etc.) such as a volatile memory device or a non-volatile memory device.

The cache and memory controllers 314, 334 can communicate with the fabric using a CXL-based Platform Interface (CPI). The CXL-based Platform Interface (CPI) can be an interface for device-to-device communication within a CXL-based platform. The CPI can be configured or designed to control or manage interactions between the CXL-based device and other platform components. The CPI can support resource management and integration with an operating system within the host 304 or the memory system 306. For example, the CPI can support data transfer, memory sharing, and resource management between devices.

The CPI can communicate device status and performance information through interaction with the operating system. The CPI can support or allow mapping of different protocols on a same physical wire. For example, the cache protocol (CXL.cache) and the memory management protocol (CXL.mem) can be mapped to the CPI. Depending on whether the component is a downstream or upstream port, different channels for the cache protocol (CXL.cache) and the memory management protocol (CXL.mem) can be adaptively associated with the agent-to-fabric (A2F) direction or the fabric-to-agent (F2A) direction.

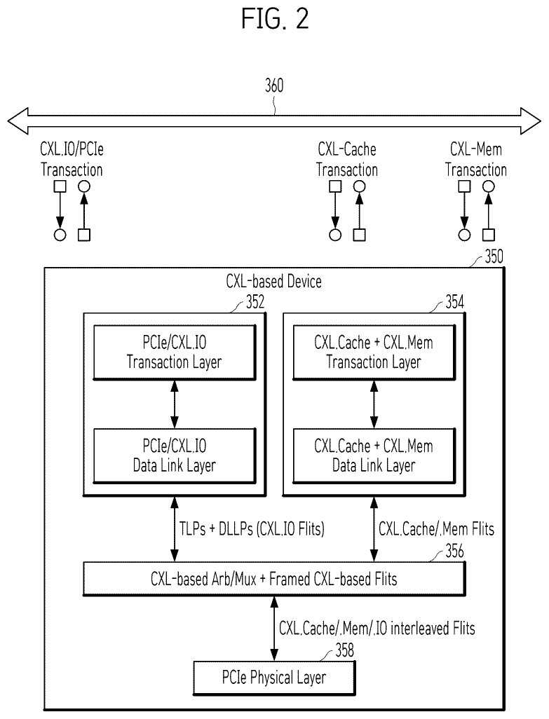

FIG. 2 is a diagram illustrating a configuration of a memory system in accordance with an embodiment of the present disclosure. Specifically, FIG. 2 illustrates a CXL-based device 350 included in the host 304 or the memory system 306 described in FIG. 1.

Referring to FIG. 2, the CXL-based device 350 can be connected to a bus interface 360 that can transmit and receive data or signals with internal components of a system such as the host 304 or the memory system 306. Through the bus interface 360, the CXL-based device 350 can transmit or receive signals and data according to various protocols described in FIG. 1. The various protocols can include the I/O protocol (CXL.io), the cache protocol (CXL.cache), the memory management protocol (CXL.mem), a PCIe protocol, etc. The CXL-based device 350 can be used for high-bandwidth devices such as accelerators and GPUs. In response to the increasing demand for high-performance computing (HPC), the CXL-based device 350 can provide a high bandwidth and low latency connection between the host 304 and a device such as an accelerator, the memory system 306, etc.

In an embodiment, the CXL-based device 350 can include a first controller 352, a second controller 354, an arbitrator and multiplexer (CXL ARB/MUX+Framed CXL Flits) 356, and a PCIe physical layer 358. Here, the first controller 352 can have a layered structure including a transaction layer and a link layer capable of controlling the flows of signals and data according to the I/O protocol (CXL.IO) or a PCIe protocol. The first controller 352 can correspond to the I/O controller 312, 332 described in FIG. 1.

Likewise, the second controller 354 can have a layered structure including a transaction layer and a link layer capable of controlling the flow of signals and data based on the cache protocol (CXL.Cache) and the memory management protocol (CXL.Mem). The second controller 354 can correspond to the cache and memory controller 314, 334 shown in FIG. 1.

The arbiter and multiplexer 356 can be used to facilitate the use of the PCIe physical layer 358. The arbiter and multiplexer 356 can dynamically multiplex data coming from various protocols (e.g., CXL.IO, CXL.Cache, CXL.Mem) and route the data to the PCIe physical layer 358. The arbiter and multiplexer 356 can correspond to the arbiter and multiplexer 316, 336 described in FIG. 1. The PCIe physical layer 358 can correspond to the Flex Bus physical layer 318, 338 described in FIG. 1.

The arbiter and multiplexer 356 can perform various operations. The arbiter and multiplexer 356 can be used to share a same physical layer with multiple link layers. The arbiter and multiplexer 356 can be configured to perform a function of multiplexing traffics of multiple protocols. In addition, the arbiter and multiplexer 356 can arbitrate a FLIT (flow control unit or flow control digit), which is based on the I/O protocol (CXL.IO), the cache protocol (CXL.Cache), and the memory management protocol (CXL.Mem), during transmission or perform data steering during reception. The flit can be a link-level atomic piece that forms a network packet or stream. Herein, the FLIT can refer to a message transmitted through the CPI that expresses an amount of data transmitted in one clock cycle on a physical channel. In some physical channels, a message can include two or more FLITs. In the CPI, FLITS can be called pumps, and FLITs can refer to data messages transmitted from the fabric.

According to an embodiment, the arbiter and multiplexer 356 can support a function to bypass the arbiter and multiplexer 356 when accessing a link layer in a PCIe-only mode is required.

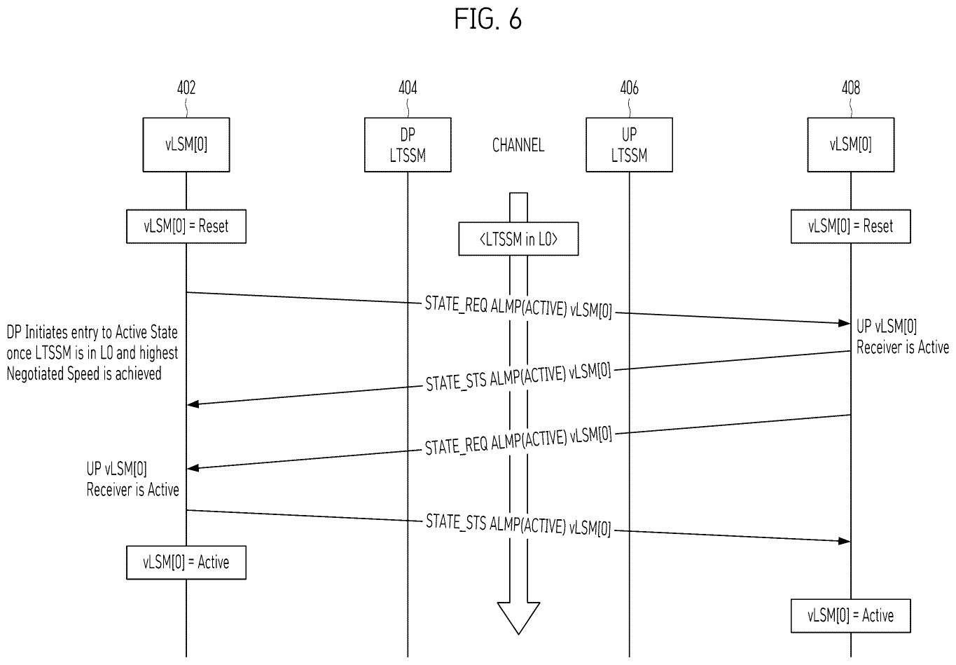

In addition, the arbiter and multiplexer 356 can support a virtual link state machine (vLSM) to help each layer synchronize with a link state. In addition, the arbiter and multiplexer 356 can enable one protocol to be in a performance measurement (PM) state, while another protocol is in the active state via a virtualized active state or the PM state per the link layer. The arbiter and multiplexer 356 can perform state synchronization to maintain a strong handshake while plural Link Training State Machines (LTSSMs) transition to recovery. In this regard, specific operations of the CXL-based device 350 will be described later with reference to FIG. 6.

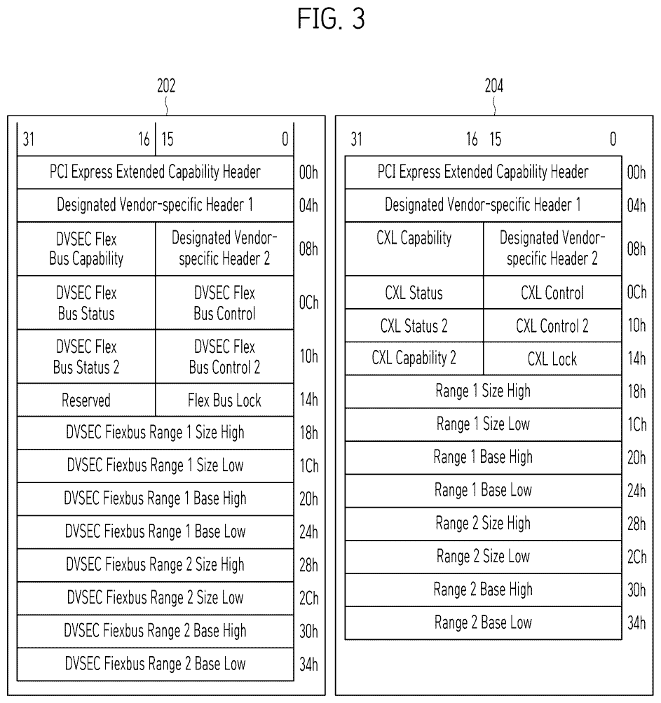

FIG. 3 is a diagram for describing a difference in register configurations within a memory system according to another embodiment of the present disclosure.

Referring to FIG. 3, the CXL-based device can include different register configurations 202, 204 based on different interface versions. For example, the CXL-based device can set the register configuration 202 according to the interface version 1.1. According to an embodiment, the CXL-based device can set the register configuration 204 according to the interface version 2.0. The register configurations 202, 204 in the CXL-based device can be linked or mapped to separate regions called configuration spaces or memory-mapped spaces. Configuration space registers can be accessed using configuration reads and configuration writes, and memory-mapped space registers can be accessed using memory reads and memory writes.

The interface versions that can be supported by multiple devices (e.g., the host 304, the memory system 306, etc.) coupled through the computer-memory communication link 302 described in FIG. 1 can be different. Typically, the interface version can be determined at the time of manufacturing of the host 304, the memory system 306, etc., or can be determined through an update during use of the host 304, the memory system 306, etc. The interface versions supported by multiple devices coupled via the computer-memory communication link 302 can be different, and the register configuration can be different depending on different interface versions. In this situation, it can be difficult to perform effective data communication between devices. Therefore, the CXL-based device 350 described in FIG. 2 can be configured to detect the difference in interface versions with another device connected via the computer-memory communication link 302, and to eliminate, avoid or reduce the difference in register configuration based on the difference of the interface versions, thereby improving or enabling effective data communication.

The CXL-based interface or the CXL-based protocol can present a register, e.g., Designated Vendor-Specific Extended Capabilities (DVSEC) register, which can be additionally configured in addition to the configuration of standardized registers. This is a memory space or a memory region which a manufacturer can set to improve or enhance performance. The CXL-based device 350 included in plural devices coupled via the computer-memory communication link 302 can transfer, receive, or exchange information regarding additionally set registers based on performance, services, etc. which each device could provide or support.

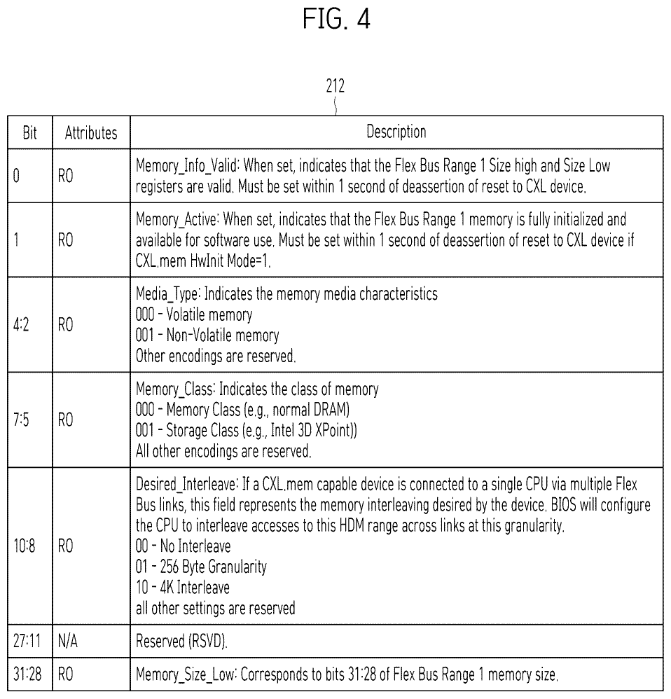

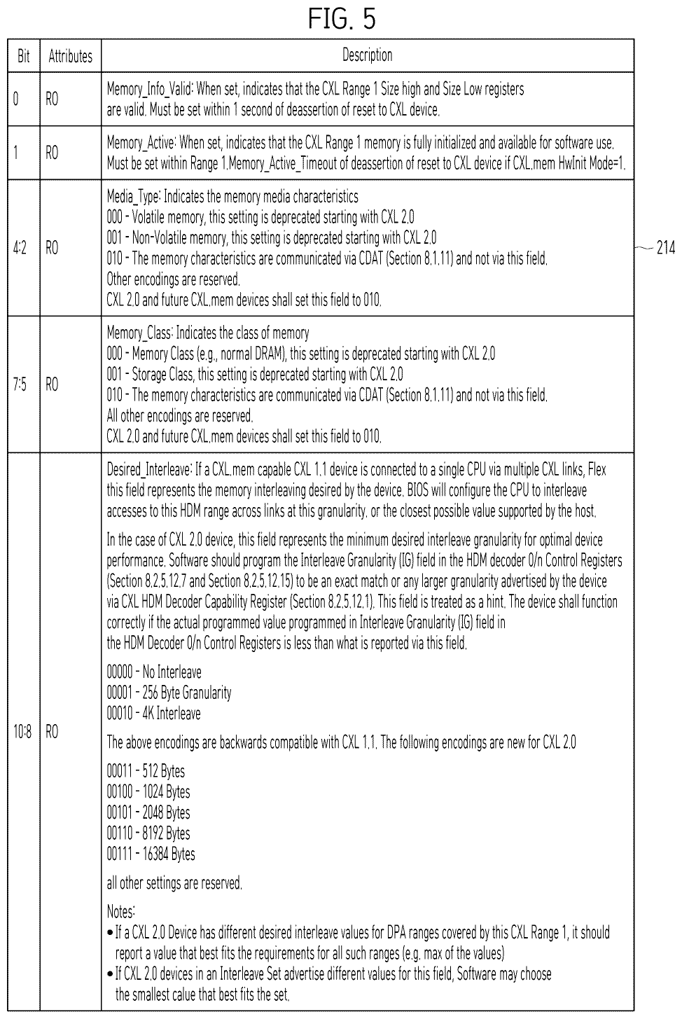

FIG. 4 is a diagram for describing a first register configuration within the memory system. FIG. 5 is a diagram for describing a second register configuration within the memory system. Specifically, FIG. 4 illustrates additionally configurable registers (e.g., Designated Vendor-Specific Extended Capabilities (DVSEC) registers) presented in the CXL-based interface version 1.1 for the Flex Bus physical layer 318, 338. On the other hand, FIG. 5 illustrates additionally configurable registers (e.g., Designated Vendor-Specific Extended Capabilities (DVSEC) registers) presented in the CXL-based interface version 2.0 for the Flex Bus physical layer 318, 338.

The additionally configurable registers (DVSEC registers) can be set or established to provide an extended function set by a vendor that supplies a device which is capable of performing data communication based on a PCIe interface. The configuration space registers defined in the CXL-based interface are grouped into blocks. Each block can be enumerated as a vendor-defined extended function (DVSEC) structure according to the PCIe interface. The identifier (ID) field for the registers that can be additionally configured can be set to a preset value. The more additional functions that a supplier can provide, the larger the space or region of the registers that could be additionally configured.

Referring to FIGS. 4 and 5, there is a difference in the register configurations for the Flex Bus physical layer 318, 338 based on the interface versions. For example, the register configuration 212 shown in the CXL-based interface version 1.1 described in FIG. 4 can be set or designed for supporting one Flex Bus. The register configuration 212 can be stored in the Root Complex Register Block (RCRB) and be exposed as the Root Complex Integrated Endpoints (RCIEP).

In contrast, the register configuration 214 described in FIG. 5 is presented in the CXL-based interface version 2.0. Herein, the register configuration 214 can be enumerated as PCIe endpoints. The register configuration 214 can be shown under a root port or a CXL-based switch, shown in FIG. 10, supporting the CXL-based interface version 2.0. The information exposed as a PCIe endpoint (EP) can include a PCIe device number and one or more function numbers for the auxiliary bus number of the upper port. This information can include information regarding additionally configurable registers (DVSEC registers). Software included in a device supporting the CXL-based interface version 2.0 can also distinguish a CXL-based device from a PCIe device based on whether or not information regarding additionally configurable registers (DVSEC registers) is exposed. For example, the CXL-based device can expose information about additionally configurable registers (DVSEC registers). However, a PCIe device could not expose information about additionally configurable registers (DVSEC registers).

FIG. 6 is a sequence diagram for describing a first Link Training State Machine (LTSSM) operation according to an embodiment of the present disclosure. Specifically, FIG. 6 illustrates a handshaking operation among LTSSM operations performed by virtual link state machines (vLSMs) included in multiple CXL-based devices.

Referring to FIG. 1 and FIG. 6, each of two devices or systems coupled via the computer-memory communication link 302 can include a virtual link state machine 402, 408. The first virtual link state machine 402 can perform an LTSSM operation 404 of downstream ports (i.e., DP LTSSM), and the second virtual link state machine 408 can perform an LTSSM operation 406 of upstream ports (i.e., UP LTSSM). According to an embodiment, the LTSSM operation 404, 406 can include a first operation for determining a data communication speed with the first host and a second operation for determining the controller register configuration.

Each of the two devices or systems can maintain a virtual link state machine (vLSM) 402, 408 for each link layer. The virtual link state machine 402, 408 can remotely coordinate state transitions with the arbiter and multiplexer 316, 336 through link management packets, e.g., ARB/MUX Link Management Packets (ALMPs). The virtual link state machine 402, 408 can determine link state requests for the Flex Bus physical layer 318, 338.

The link management packet (ALMP) delivered to the arbiter and multiplexer 316, 336 is used to convey requests and states for virtual link state transition. The link management packet (ALMP) can be a single DW packet that can be replicated four times in the lower 16 bytes of a 528-bit flit to provide data integrity protection. The link management packet (ALMP) can be classified into two types: one is used as a request for switching the Active/PM state of the virtual link state machine (vLSM), and the other is used to convey the current state to a remotely coupled partner (another virtual link state machine). When a switching request via the link management packet (ALMP) is not accepted, the link management packet (ALMP) conveying the current state is not transmitted, and the virtual link state machines 402, 408 can both maintain the current state. In addition, when the link management packet (ALMP) is not normally received or an error occurs, the LTSSM operation can switch to a recovery operation or perform a retrain of the computer-memory communication link 302.

Referring to FIG. 6, handshaking via the link management packet (ALMP) goes through a process in which the virtual link state machines 402, 408 are synchronized with each other as partners. The entry into the Active state of the virtual link state machine (vLSM) can be initiated from the downstream ports. Afterwards, the transition can be initiated from either the downstream ports or the upstream ports. The virtual link state machines 402, 408 should send and receive link management packets (ALMPs) requesting an active state transition to each other. When a port of the virtual link state machine 402, 408 is ready to receive a FLIT, an active link management packet (ALMP) (e.g., a message for transition from Reset to Active) could be returned. After the virtual link state machines 402, 408 individually forward and receive link management packets (ALMPs) in both directions, all ports of the virtual link state machines 402, 408 could be ready (i.e., active state).

After the virtual link state machines 402, 408 are ready, the virtual link state machines 402, 408 can be configured to send and receive link management packets (ALMPs) including the current state or send and receive link management packets (ALMPs) according to a status synchronization protocol. Through this procedure, the virtual link state machines 402, 408 of two devices or systems can exchange interface versions or information which can be individually used by the two devices or systems for register configuration.

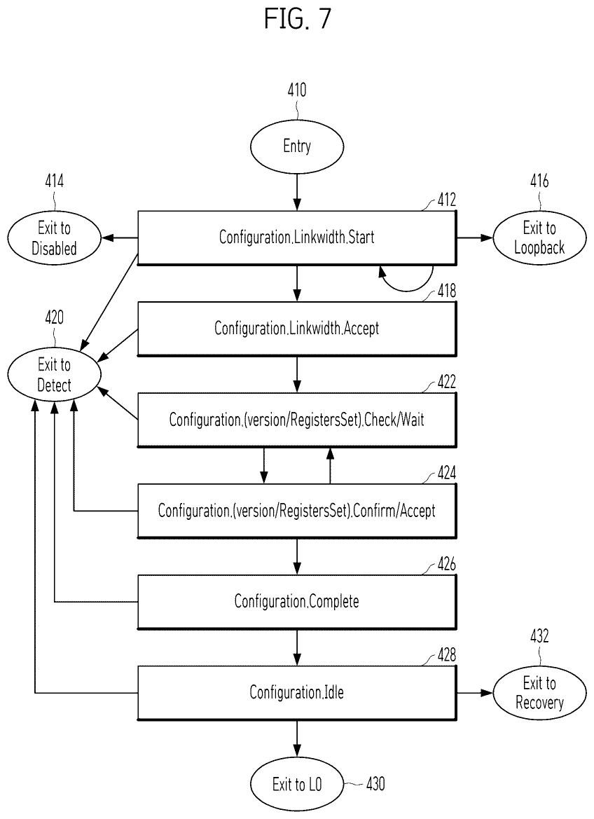

FIG. 7 is a flowchart for describing a second LTSSM operation according to an embodiment of the present disclosure. Specifically, FIG. 7 illustrates an LTSSM operation for utilizing a PCIe device for CXL-based mode link-up using alternate protocol Negotiation (APN) technology.

According to an embodiment, a device including an interface version which is not supported or a CXL-based interface version which is not checked or recognized can be coupled or added via a network or the computer-memory communication link 302. Alternate Protocol Negotiation (APN) can help enable data communication via a non-PCIe protocol utilizing the PCIe physical layer. In addition, it can be possible to choose for the device to operate based on one or more alternate protocols as well as a PCIe protocol during an alternate protocol mode. This can be enabled through negotiation (e.g., exchange of information) during an LTSSM operation for configuration while the partners coupled via the computer-memory communication link 302 or the PCIe physical layer can communicate their functions with each other.

Referring to FIG. 7, an LTSSM operation for configuration can be initiated (operation 410). For example, a negotiation process could be started via a downstream port (DSP) supporting the alternative protocol negotiation (APN) when a value of a specific field is input as a preset value. First, a negotiation on the number of links (Linkwidth) can be started with a partner coupled through the links (operation 412). When both devices of the partner can support the number of links (Linkwidth), the number of links (Linkwidth) could be accepted (operation 418). When the negotiation process is impossible (operation 414) or the negotiation process is not performed normally (operation 416), the negotiation process could be terminated (Exit). In another case, when information of the partner is not checked or confirmed during the negotiation process, the negotiation process could be terminated (operation 420). According to an embodiment, the partner coupled through the link could attempt or carry out negotiation regarding a bandwidth or number of lines (Lane number, Linkwidth).

When the negotiation regarding the link width or the bandwidth is accepted (operation 418), the register configuration of the partner coupled via the link can be checked (operation 422), and whether the register configurations of each other are compatible could be accepted (operation 424). When the register configuration of the partner coupled via the link cannot be confirmed or it is difficult to maintain compatibility in the register configuration of each other, the negotiation process may be terminated (operation 420).

Afterwards, it can be checked whether the negotiation regarding the configuration for data communication between the partners coupled via the link has been completed (operation 426). The partner coupled via the link can finalize configuration for data communication (operation 428). When all states are determined, the LTSSM operation could be terminated (operation 430). Otherwise, when another error might occur, a recovery operation can be performed (operation 432).

In an embodiment, the alternative protocol negotiation (APN) could be completed after the partners coupled via the link sequentially determines whether a preset configuration is activated. When the activation of the preset configuration is not determined, the LTSSM operation can be switched to a mode for finding the activation (operation 420). During the Alternative Protocol Negotiation (APN) process, the termination of the negotiation processes (operations 414, 416, 420) or the termination of the LTSSM operation (operation 430) can be done from various progress states. According to an embodiment, the termination could be followed by a next negotiation. This scheme can allow for more clearly specifying an issue that should be resolved for data communication with the partners connected through the link.

The partners coupled via the link first can exchange information regarding the physical layer. Once exchange or negotiation regarding the physical layer are completed, the register configuration based on the interface version or the exchange and negotiation regarding the functions and services supported by the link layer can be performed. For example, the exchange or negotiation can specify or check which partners activate a function based on the CXL-based protocol by being coupled via the link and whether the partners operate in a mode of the interface version 1.1 or 2.0.

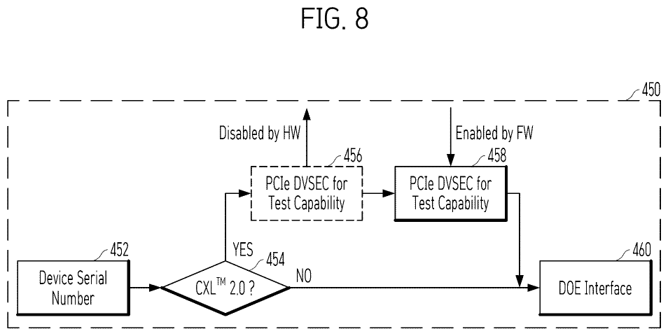

FIG. 8 is a flowchart for describing an operation for register configuration of a memory system according to an embodiment of the present disclosure.

Referring to FIG. 8, the memory system can receive unique information regarding a device or component from an external device such as the host coupled via the computer-memory communication link 302 (operation 452). Upon receiving unique information of the external device, the memory system can check whether the device or component is configured to support data communication under a preset CXL-based interface version (e.g., CXL™ 2.0) (operation 454). When the device or component supports the preset CXL interface version (e.g., CXL™ 2.0), the memory system can check or determine compatibility of internal components 456, 458. When it is determined that there is no compatibility, the memory system can disable or inactivate a preset corresponding internal component (Disabled by HW). Otherwise, when it is determined that there is compatibility, the memory system can enable or use the preset corresponding internal component (Enabled by FW).

According to an embodiment, the memory system can store or add information regarding whether the internal component is enabled in a firmware binary. The firmware binary can refer to a single file (or system data) of software code used in a specific hardware device or system. The memory system can control or perform operations based on values or information stored in the firmware binary. The memory system can secure, from the firmware binary, at least some codes or values which are used to carry out initialization or setting for data communication.

Afterward, the memory system can perform an operation for data object exchange (DOE) with the external device through the computer-memory communication link 302 (operation 460). The data object exchange (DOE) can be a PCI SIG-defined mechanism for the host to perform a PCIe function or a data object exchange function. The DOE can be used for data transfer and data sharing between various devices. The DOE can be designed to enable fast and efficient transfer of data objects between the devices, so that data transfer or movement can be performed smoothly between CPUs and various accelerators (e.g., GPU, FPGA, etc.), as well as the settings for memory pooling and resource allocation therebetween could be enabled or allowed. Further, the DOE can support various data formats, so that data compatibility between different devices can be enhanced. Here, a data object can point to a block of data (or a data set) in a specific format which can be transferred between the devices. For example, the data object can include metadata related to a memory address (e.g., a memory address for the register configuration). The DOE can include a mechanism to handle or cure an error, which may occur during data transmission, for error handling and validation.

FIG. 9 is a diagram illustrating a configuration of a data processing apparatus according to an embodiment of the present disclosure. Herein, the data infrastructure can include devices or components coupled via the computer-memory communication link (e.g., CXL™ link) 302 shown in FIG. 1. Specifically, FIG. 9 illustrates a plurality of hosts, a plurality of logical devices, a Compute Express Link-based (CXL-based) switch, and a Compute Express Link-based (CXL-based) interface included in the data infrastructure.

Referring to FIG. 9, the data infrastructure can include a plurality of hosts (H1, H2, . . . , H #) 502A, 502B, . . . , 502 #, 512A, 512B, 522A and a plurality of logical devices (LD1, LD2, . . . , LD #) 510A, 510B, . . . , 510 #, 520A, 520B. The plurality of hosts 502A, 502B, . . . , 502 #, 512A, 512B, 522A and the plurality of logical devices 510A, 510B, . . . , 510 #, 520A, 520B can be coupled by a connection device 550 including at least one CXL-based switch 550A, 550B, 550C.

Data infrastructure may refer to a digital infrastructure that promotes data sharing and consumption. Like other infrastructures, the data infrastructure can include structures, services, and facilities that are needed for data sharing and consumption. For example, the data infrastructure includes a variety of components, including hardware, software, networking, services, policies, and etc. that enable data consumption, storage, and sharing. The data infrastructure can provide a foundation for creating, managing, using, and protecting data.

For example, the data infrastructure can be divided into physical infrastructure, information infrastructure, business infrastructure, and the like. The physical infrastructure may include a data storage device, a data processing device, an input/output network, a data sensor facility, and the like. The information infrastructure may include data repositories such as business applications, databases, and data warehouses, virtualization systems, and cloud resources and services including virtual services, and the like. The business infrastructure may include business intelligence (BI) systems and analytics tools systems such as big data, artificial intelligence (AI), machine learning (ML), and the like.

The plurality of host systems 502A, 502B, . . . , 502 #, 512A, 512B, 522A can be understood as computing devices such as personal computers and workstations. For example, a first host system 502A can include a host processor (CPU), a host memory. The host processor (CPU) can perform data processing operations in response to user's needs, temporarily store data used or generated in the process of performing the data processing operations in the host memory as an internal volatile memory, or transfer and store the data in the plurality of logical devices 510A, 510B, . . . , 510 #, 520A, 520B as needed.

When a user performs tasks that require many high speed operations, such as calculations or operations related to artificial intelligence (AI), machine learning (ML), and big data, resources such as a host memory 106 included in the first host system 502A might not be sufficient. The plurality of logical devices 510A, 510B, . . . , 510 #, 520A, 520B coupled to the first host system 502A can be used to overcome a limitation of internal resources such as the host memory 106.

Referring to FIG. 9, the connection device 550 can couple the plurality of host processors 502A, 502B, . . . , 502 #, 512A, 512B, 522A and the plurality of logical devices 510A, 510B, . . . , 510 #, 520A, 520B to each other. According to an embodiment, some of host processors could constitute a single system. In another embodiment, each host processor could be included in a distinct and different system. Further, according to an embodiment, some of logical devices could constitute a single shared memory device. In another embodiment, each logical device could be included in a distinct and different shared memory device.

A data storage area included in the plurality of logical devices 510A, 510B, . . . , 510 #, 520A, 520B can be exclusively assigned or allocated to the plurality of host systems 510A, 510B, . . . , 510 #, 520A, 520B. For example, the entire storage space of the storage LD1 of first logical device 510A may be exclusively allocated to and used by the first host system 502A. That is, another host system might not access the storage LD1 in first logical device 510A while the storage LD1 is allocated to the first host system 502A. A partial storage space in the storage LD2 of second logical device 510B may be allocated to the first host system 504A, while another portion therein may be allocated to the third host system 504C. In addition, a partial storage space in the storage LD2 of second logical device 510B might not be used by another host system except for the storage LD2 of second logical device. The storage LD3 of third logical device 510C may be allocated to, and used by, the second host system 504B and the third host system 512A. The storage LD4 of fourth logical device 510D may be allocated to, and used by, the first host system 504A, the second host system 504B, and the third host system 512A.

In the plurality of logical devices 510A, 510B, . . . , 510 #, 520A, 520B, unallocated storage spaces can be further allocated to the plurality of host systems 510A, 510B, . . . , 510 #, 520A, 520B based on a request of the plurality of host systems 510A, 510B, . . . , 510 #, 520A, 520B. Further, the plurality of host systems 510A, 510B, . . . , 510 #, 520A, 520B can request deallocation or release of the previously allocated storage space. In response to the request of the plurality of host systems 510A, 510B, . . . , 510 #, 520A, 520B, the connection device 550 can control connection or data communication between the plurality of host systems 510A, 510B, . . . , 510 #, 520A, 520B and the plurality of logical devices 510A, 510B, . . . , 510 #, 520A, 520B.

Referring to FIG. 9, the plurality of host systems 510A, 510B, . . . , 510 #, 520A, 520B may include the same component, but their internal components may be changed according to an embodiment. In addition, the plurality of logical devices 510A, 510B, . . . , 510 #, 520A, 520B may include the same component, but their internal components may be changed according to an embodiment.

According to an embodiment, the connection device 550 can be configured to utilize the plurality of logic devices 510A, 510B, . . . , 510 #, 520A, 520B to provide versatility and scalability of resources, so that the plurality of host systems 510A, 510B, . . . , 510 #, 520A, 520B can overcome limitations of internal resources. Herein, Compute Express Link (CXL-based) is a type of interface which utilizes different types of devices more efficiently in a high-performance computing system such as artificial intelligence (AI), machine learning (ML), and big data. For example, when the plurality of logical devices 510A, 510B, . . . , 510 #, 520A, 520B includes a CXL-based-based DRAM device, the plurality of host systems 510A, 510B, . . . , 510 #, 520A, 520B may expand memory capacity available for storing data.

When the connection device 550 provides cache consistency, there may be delays in allowing other processors to use variables or data updated by a specific processor in a process of sharing the variables or the data stored in a specific memory area. To reduce the delay in using the plurality of logical devices 510A, 510B, . . . , 510 #, 520A, 520B, a Compute Express Link (CXL-based) protocol or interface through the CXL-based switch 120 can assign a logical address range to memory areas in the plurality of logical devices 510A, 510B, . . . , 510 #, 520A, 520B. The logical address range is used by the plurality of host systems 510A, 510B, . . . , 510 #, 520A, 520B. Using a logical address in the logical address range, the plurality of host systems 510A, 510B, . . . , 510 #, 520A, 520B can access the memory areas allocated to the plurality of host systems 510A, 510B, . . . , 510 #, 520A, 520B. When each of the plurality of host systems 510A, 510B, . . . , 510 #, 520A, 520B requests a storage space for a specific logical address range, an available memory area included in the plurality of logical devices 510A, 510B, . . . , 510 #, 520A, 520B can be allocated for the specific logical address range. When each of the plurality of host systems 510A, 510B, . . . , 510 #, 520A, 520B requests a memory area based on different logical addresses or different logical address ranges, memory areas in the plurality of logical devices 510A, 510B, . . . , 510 #, 520A, 520B can be allocated for the different logical addresses or the different logical address ranges. When the plurality of host systems 510A, 510B, . . . , 510 #, 520A, 520B does not use a same logical address range, however, then a variable or data assigned to a specific logical address might not be shared by the plurality of host systems 510A, 510B, . . . , 510 #, 520A, 520B. Each of the plurality of host systems 510A, 510B, . . . , 510 #, 520A, 520B can use the plurality of logical devices 510A, 510B, . . . , 510 #, 520A, 520B as a memory expander to overcome limitations of their internal resources.

According to an embodiment, the plurality of logic devices 510A, 510B, . . . , 510 #, 520A, 520B may include a controller and a plurality of memories. The controller could be connected to the connection device 550 and control the plurality of memories. The controller can perform data communication with the connection device 550 through a Compute Express Link (CXL-based) interface. Further, the controller can perform data communication through a protocol and an interface supported by the plurality of memories. According to an embodiment, the controller can distribute data input/output operations transmitted to a shared memory device and manage power supplied to the plurality of memories in the shared memory device. Depending on an embodiment, the plurality of memories can include a dual in-line memory module (DIMM), a memory add-in card (AIC), a non-volatile memory device supporting various connections (e.g., EDSFF 1U Long (E1 L.), EDSFF 1U Short (E1 S.), EDSFF 3U Long (E3U Long), EDSF (E3U Short), etc.).

The memory areas included in the plurality of logical devices 510A, 510B, . . . , 510 #, 520A, 520B may be allocated for, or assigned to, the plurality of host systems 510A, 510B, . . . , 510 #, 520A. A size of memory area allocated for, or assigned to, the plurality of host systems 510A, 510B, . . . , 510 #, 520A can be changed or modified in response to a request from the plurality of host systems 510A, 510B, . . . , 510 #, 520A. In FIG. 9, it is shown that the plurality of host systems 510A, 510B, . . . , 510 #, 520A is coupled to the plurality of logic devices 510A, 510B, . . . , 510 #, 520A, 520B through the connection device 550. However, according to an embodiment, the storage areas included in the plurality of logical devices 510A, 510B, . . . , 510 #, 520A, 520B may also be allocated for, or assigned to, a virtual machine (VM) or a container. Herein, a container is a type of lightweight package that includes application codes and dependencies such as programming language runtimes and libraries of a specific version required to run software services. The container could virtualize the operation system. The container can run anywhere from a private data center to a public cloud or even on a developer's personal laptop.

According to an embodiment, at least one host and at least one logical device or memory system can perform data communication through a CXL-based interface or CXL-based protocol that supports memory pooling and memory sharing. The memory pooling can allow multiple hosts of a heterogeneous topology to access a common memory address range, and each host can be assigned a non-overlapping address range from a pool of memory resources. Through the memory pooling, a data infrastructure or a data processing apparatus can dynamically allocate a storage area or a memory area within the pool, thereby reducing wasted memory and increasing memory utilization. The CXL-based interface or CXL-based protocol can provide effects such as efficient memory allocation, guaranteed memory access, memory isolation between multiple hosts or processors, and data or system security.

The memory sharing can allow multiple hosts of a heterogeneous topology to access a common memory address range, and each host and other hosts may be assigned the same address range. Because multiple hosts can access the same data, data flow can be efficient, but the data infrastructure or data processing apparatus can manage coherency between the hosts to avoid data from being incorrectly overwritten by other hosts. The CXL-based interface or CXL-based protocol can provide effects such as efficient data communication, low latency, and reduced power consumption between multiple hosts or processors.

According to an embodiment, the plurality of host systems 510A, 510B, . . . , 510 #, 520A can send raw commands to the plurality of logical devices 510A, 510B, . . . , 510 #, 520A, 520B. A raw command can send a command or code (opcode) specified by user space to the underlying hardware and bypass all driver checks for the command. The raw command is one of the commands supported by the CXL-based protocol or interface or promised by vendors. The raw command can enable direct control of a specific hardware device. Additionally, operations such as memory accesses or data read/write operations through register configuration promised by the vendor can be transferred to a mailbox through the raw command, etc.

FIG. 10 is a diagram illustrating a configuration of a computer-memory link-based switch according to an embodiment of the present disclosure. Herein, the CXL-based switch can be coupled to other devices or components via the computer-memory communication link (e.g., CXL™ link) 302 shown in FIG. 1. The CXL-based switch 120 described in FIG. 10 can correspond to at least one CXL-based switch 550A, 550B, 550C included in the connection device 550 described in FIG. 12.

Referring to FIG. 10, a plurality of root ports (H1 Root Port, H2 Root Port) 108A, 108B and a plurality of logic devices (LD1 to LD4) 110A, 110B, 110C, 110D may be coupled through a CXL-based switch 120.

According to an embodiment, the plurality of root ports 108A, 108B may be included in a root complex located between the plurality of logical devices 110A, 110B, 110C, 110D supporting a Compute Express Link-based (CXL-based) interface and the plurality of host processors 502A, 502B, 502C, 502 # shown in FIG. 9. The root complex is an interface located between the plurality of host processors 502A, 502B, 502C, 502 # and a connection component such as a PCIe Bus. The root complex may include several components, several chips, system software, and the like, such as a processor interface, a DRAM interface, and the like. The root complex can logically combine hierarchical domains such as PCIe into a single hierarchy. Each fabric instance may include a plurality of logical devices, switches, bridges, and the like. The root complex can calculate a size of a storage space in each logical device and map the storage space to an operating system, to generate an address range table. According to an embodiment, the plurality of host processors 502A, 502B, 502C, 502 # may be connected to different root ports 108A, 108B respectively to configure different host systems.

The root ports 108A, 108B may refer to a PCIe port included in the root complex that forms a part of PCIe interconnection hierarchy through a virtual PCI-PCI bridge which is coupled to the root ports 108A, 108B. Each of the root ports 108A, 108B may have a separate hierarchical area. Each hierarchical area may include one endpoint, or sub-hierarchies including one or more switches or a plurality of endpoints. Herein, an endpoint may refer to one end of the communication channel. The endpoint may be determined according to circumstances. For example, in a case of physical data communication, an endpoint may refer to a server or a terminal, which is the last device connected through a data path. In terms of services, an endpoint may indicate an Internet identifier (e.g., uniform resource identifiers, URIs) corresponding to one end of the communication channel used when using a service. An endpoint may also be an Internet identifier (URIs) that enables an Application Programming Interface (API), which is a set of protocols that allow two systems (e.g., applications) to interact or communicate with each other, to access resources on a server.

The CXL-based switch 120 is a device that can attach the plurality of logical devices 110A, 110B, 110C, 110D, which are multiple devices, to one root port 108A or 108B. The CXL-based switch 120 can operate like a packet router and recognize which path a packet should go through based on routing information different from an address of the packet. Referring to FIG. 10, the CXL-based switch 120 can include a plurality of bridges.

Here, Compute Express Link-based (CXL-based) is a dynamic multi-protocol technology designed to support accelerators and memory devices. The computer-memory communication link (e.g., CXL™ link) 302 can provide a set of protocols including protocols (e.g., CXL.io) that include PCIe-like I/O semantics, protocols (e.g., CXL.cache) that include caching protocol semantics, and protocols including memory access semantics over individual or on-package (on-package) links. Semantics may refer to prediction and ascertainment of what will happen and what the outcome will be to the meaning given by units such as expressions, sentences, and program codes when a program or an application, which is configured of a language which is a type of communication system governed by sentence generation rules in which elements are combined in various ways. For example, a first CXL-based protocol (CXL.io) can be used for search and enumeration, error reporting, and Host Physical Address (HPA) inquiry. A second CXL-based protocol (CXL.mem) and a third CXL-based protocol (CXL.cache) may be selectively implemented and used by a specific accelerator or a memory device usage model. The CXL-based interface can provide low-latency, high-bandwidth paths for an accelerator to access a system or for a system to access a memory connected to a memory system.

The Compute Express Link-based (CXL-based) switch 120 is an interconnect device for connecting the plurality of root ports 108A, 108B and the plurality of logic devices 110A, 110B, 110C, 110D supporting CXL-based data communication. For example, the plurality of logical devices 110A, 110B, 110C, 110D may refer to a PCIe-based device or a logical device LD. Here, PCIe (i.e., Peripheral Component Interconnect Express) can refer to a protocol or an interface for connecting a computing device and a peripheral device. Using a slot or a specific cable to connect a host such as a computing device to a memory system such as a peripheral device connected to the computing device, PCIe can have a bandwidth over several hundreds of MBs per second (e.g., 250 MB/s, 500 MB/s, 984.6250 MB/s, 1969 MB/s, etc.) by using a plurality of pins (e.g., 18, 32, 49, 82, etc.) and at least one wire (e.g., x1, x4, x8, x16). Using CXL-based switching and pooling, the plurality of host processors and the plurality of logical devices can be connected through the CXL-based switch 120, and all or a part of each logical device connected to the CXL-based switch 120 can be assigned as a logical device to several host processors. A logical device LD is an entity that refers to a CXL-based endpoint bound to a virtual CXL-based switch (VCS).

According to an embodiment, the logical device LD may include a single logical device (Single LD) or a multi-logical device (MLD). The plurality of logical devices 110A, 110B, 110C, 110D that support the Compute Express Link-based (CXL-based) interface could be partitioned into up to 16 distinguished logical devices like a memory managed by the host. Each logical device can be identified by a logical device identifier LD-ID used in the first CXL-based protocol (CXL.io) and the second CXL-based protocol (CXL.mem). Each logical device can be identified in the virtual hierarchy (VH). A control logic or circuit included in each of the plurality of logic devices 110A, 110B, 110C, 110D may control and manage a common transaction and link layer for each protocol. For example, the control logic or circuit in the plurality of logic devices 110A, 110B, 110C, 110D can access various architectural functions, control, and status registers through an Application Programming Interface (API) provided by a fabric manager 130, so that the logic device LD can be configured statically or dynamically.

Referring to FIG. 10, the CXL-based switch 120 can include a plurality of virtual CXL-based switches 122, 124. The virtual CXL-based switch (VCS) 122, 124 may include entities within a physical switch belonging to a single virtual hierarchy (VH). Each entity may be identified using a virtual CXL-based switch identifier VCS-ID. The virtual hierarchy (VH) may include a rendezvous point (RP), a PCI-to-PCI bridge (PPB) 126, and an endpoint. The virtual hierarchy (VH) may include everything arranged under the rendezvous point (RP). The structure of the CXL-based virtual layer may be similar to that of PCIe. A port connected to a virtual PCI-PCI bridge (vPPB) and a PCI-PCI bridge (PPB) inside a CXL-based switch 120 controlled by the fabric manager (FM) 130 can provide or block connectivity in response to various protocols (PCIe, CXL™ 1.1, CXL™ 2.0 SLD, CXL™ 2.0 MLD, or CXL™ 3.0 MLD). Here, the fabric manager (FM) 130 can control an aspect of the system related to binding and management of pooled ports and devices. The fabric manager (FM) 130 can be considered a separate entity distinguished from a switch or host firmware. In addition, virtual PCI-PCI bridges (vPPBs) and PCI-PCI bridges (PPBs) controlled by the fabric managers (FM) 130 can provide data links including traffic from multiple virtual CXL-based switches (VCS) or unbound physical ports. Messages or signals by the fabric manager (FM) 130 can be delivered to a fabric manager (FM) endpoint 128 in the CXL-based switch 120, and the CXL-based switch 120 can control multiple switches or bridges included therein based on the message or signal delivered to the fabric manager endpoint 128.

According to an embodiment, the CXL-based switch 120 can include a PCI-PCI bridge PPB 126 corresponding to each of the plurality of logic devices 110A, 110B, 110C, 110D. The plurality of logic devices 110A, 110B, 110C, 110D may have a 1:1 corresponding relationship with the PCI-PCI bridge PPB 126. In addition, the CXL-based switch 120 can include a virtual PCI-PCI bridge (vPPB) corresponding to each of the plurality of root ports 108A, 108B. The plurality of root ports 108A, 108B and the plurality of virtual PCI-PCI bridges vPPB 122, 124 may have a 1:1 corresponding relationship. The CXL-based switch 120 may have a different configuration corresponding to the number of the plurality of root ports 108A, 108B and the number of the plurality of logic devices 110A, 110B, 110C, 110D.

Referring to FIG. 10, the fabric manager (FM) 130 may connect one virtual PCI-PCI bridge (vPPB) among the second virtual CXL-based switches 122 with one PCI-PCI bridge (PPB) among PCI-PCI bridges (PPBs) 126 and unbind other virtual PCI-PCI bridges (vPPB) included in the first CXL switches 122 and the second virtual CXL-based switches 124 to any PCI-PCI bridge (PPB) among PCI-PCI bridges (PPBs) 126. That is, connectivity between the first CXL-based switches 122, or the second virtual CXL-based switches 124, and the PCI-PCI bridges (PPBs) 126 may be achieved selectively. Like this configuration, the CXL-based switch 120 can perform a function of connecting a virtual layer to a physical layer (Virtual to Physical Binding).

Referring to FIGS. 9 and 10, the storage space (e.g., memory areas) in the plurality of logic devices 110A, 110B, 110C, 110D, . . . , 110 # may be shared by the plurality of host systems 510A, 510B, . . . , 510 #, 520A. For example, the storage space of the first logical device storage LD1 may be configured to store data corresponding to a logical address range of 1 to 100, and the storage space of the second logical device storage LD2 may be configured to store data corresponding to another logical address range of 101 to 200. The plurality of logical devices 110A, 110B, 110C, 110D can be accessed through logical addresses of 1 to 400. Further, the plurality of host systems 510A, 510B, . . . , 510 #, 520A can share access information regarding which host processor uses or accesses the storage space in the plurality of logical devices 110A, 110B, 110C, 110D based on the logical addresses of 1 to 400. For example, logical addresses of 1 to 50 may be assigned to, and allocated for, the first host system 510A, and other logical addresses of 51 to 100 may be assigned to, and allocated for, the second host system 510B. In addition, other logical addresses of 101 to 200 may be assigned to, and allocated for, the first host system 510A.

A range of logical addresses assigned to each logical device in the plurality of logical devices 110A, 110B, 110C, 110D can be different in response to a size of the storage space of the logical device included in the shared memory device. In addition, a storage space that has been allocated to the plurality of host systems 510A, 510B, . . . , 510 #, 520A may be released in response to a release request of the plurality of host systems 510A, 510B, . . . , 510 #, 520A.

As above described, a memory system according to embodiments of the present disclosure can improve compatibility by enabling data communication with at least one external device, even when a register configuration not set within the memory system according to a specific standard is required for the data communication.

The methods, processes, and/or operations described herein may be performed by code or instructions to be executed by a computer, processor, controller, or other signal processing device. The computer, processor, controller, or other signal processing device may be those described herein or one in addition to the elements described herein.

Because the algorithms that form the basis of the methods or operations of the computer, processor, controller, or other signal processing device, are described in detail, the code or instructions for implementing the operations of the method embodiments may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments herein.

The controllers, processors, control circuitry, devices, modules, units, multiplexers, generators, logic, interfaces, decoders, drivers, and other signal generating and signal processing features of the embodiments disclosed herein may be implemented, for example, in non-transitory logic that may include hardware, software, or both. When implemented at least partially in hardware, the controllers, processors, control circuitry, devices, modules, units, multiplexers, generators, logic, interfaces, decoders, drivers, and other signal generating and signal processing features may be, for example, any of a variety of integrated circuits including but not limited to an application-specific integrated circuit, a field-programmable gate array, a combination of logic gates, a system-on-chip, a microprocessor, or another type of processing or control circuit.

When implemented at least partially in software, the controllers, processors, control circuitry, devices, modules, units, multiplexers, generators, logic, interfaces, decoders, drivers, and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods or operations of the computer, processor, microprocessor, controller, or other signal processing device, are described in detail, the code or instructions for implementing the operations of the method embodiments may transform the computer, processor, controller, or other signal processing device into a special-purpose processor for performing the methods described herein.

While the embodiments of the present disclosure have been illustrated and described with respect to the specific embodiments, it will be apparent to those skilled in the art in light of the present disclosure that various changes and modifications may be made without departing from the spirit and scope of the present disclosure as defined in the following claims. Furthermore, the embodiments may be combined to form additional embodiments.

What is claimed is:

1. A memory system comprising:
at least one memory device; and
a controller configured to perform data communication with at least one external device via a computer-memory link-based interface and transfer, to the at least one memory device, an input/output request received from the at least one external device,
wherein the controller is configured to:
check a first interface version of a first external device among the at least one external device;
write, into a firmware binary, a setting value for changing a controller register configuration according to the first interface version; and
process a request received from the first external device based on the firmware binary.

2. The memory system according to claim 1, wherein the controller is further configured to perform a Link Training and Status State Machine (LTSSM) operation for configurating controller registers in response to an active state request received from the first external device.

3. The memory system according to claim 2, wherein the controller is configured to:
check the first interface version of the first external device during the LTSSM operation;
determine whether the first interface version of the first external device and the controller register configuration are compatible; and
perform data object exchange (DOE) with the first external device based on the setting value according to a compatibility to store a result of the DOE in the firmware binary.

4. The memory system according to claim 2, wherein the controller is configured to transmit, to the at least one external device, the setting value set before the LTSSM operation is performed, when the at least one external device transmits a read request for the controller register configuration during the LTSSM operation.

5. The memory system according to claim 1, wherein the controller is configured to perform a LTSSM operation for performing the data communication, when a link request according to an Active Link Management Protocol (ALMP) handshake is received from the at least one external device.

6. The memory system according to claim 1, wherein the controller, operatively engaged with a memory including an extended area available for a register configuration is configured to set, as a default value, the controller register configuration corresponding to the first interface version of the first external device, when the first interface version of the first external device is older than a version corresponding to the predetermined controller register configuration.

7. The memory system according to claim 1,
wherein the at least one external device further comprises a second external device having a second interface version different from the first interface version of the first external device, and
wherein the controller is configured to:
write, into the firmware binary, a setting value for changing the controller register configuration according to the second interface version of the second external device; and
process a request by referring to at least one of values stored in the firmware binary depending on whether the request is received from either the first external device or the second external device.

8. The memory system according to claim 7, wherein the controller is configured to add a first controller register configuration corresponding to a recent interface version among the first and second interface versions of the first and second external devices, into an extended area storing a second controller register configuration corresponding to an older interface version among the first and second interface versions of the first and second external devices.

9. The memory system according to claim 1, wherein the controller is configured to store the firmware binary in a non-volatile memory operatively engaged with the controller.

10. A computer-memory link-based apparatus comprising: a controller coupled to each of at least one host and at least one memory device,
wherein the controller comprises a processor configured to transfer an input/output request received from the at least one host to the at least one memory device and a memory configured to store a firmware binary, and
wherein the controller is configured to:
check a first interface version of a first external device among the at least one external device;
write, into a firmware binary, a setting value for changing a controller register configuration according to the first interface version; and
process a request received from the first external device based on the firmware binary.

11. The computer-memory link-based apparatus according to claim 10,
wherein the controller is configured to perform a Link Training and Status State Machine (LTSSM) operation for the controller register configuration in response to an active state request received from the first external device, and
wherein the LTSSM operation comprises:
a first operation for determining a data communication speed with the first host; and
a second operation for determining the controller register configuration.

12. The computer-memory link-based apparatus according to claim 11, wherein the controller is configured to:
check the first interface version of the first external device during the LTSSM operation;
determine whether the first interface version of the first external device and the controller register configuration are compatible; and
perform data object exchange (DOE) with the first external device based on the setting value according to a compatibility to store a result of the DOE in the firmware binary.

13. The computer-memory link-based apparatus according to claim 12, the controller is configured to transmit, to the at least one external device, the setting value set before the LTSSM operation is performed, when the at least one external device transmits a read request for the controller register configuration during the LTSSM operation.

14. The computer-memory link-based apparatus according to claim 11, wherein the controller is configured to store the firmware binary in a non-volatile memory operatively engaged with the controller.

15. A method for operating a system, the method comprising:
performing a register configuration based on a firmware binary after power is supplied;
performing a Link Training and Status State Machine (LTSSM) operation in response to an active state request received from an external device;
checking an interface version of the external device;
determining whether the interface version of the external device and the register configuration are compatible;
performing a Data Object Exchange (DOE) with the external device for a setting value based on a compatibility; and
updating the setting value and storing an updated setting value in the firmware binary.

16. The method according to claim 15, wherein performing the LTSSM operation comprises:
performing a first operation for determining a data communication speed with the external device; and
performing a second operation for determining the register configuration.

17. The method according to claim 16, further comprising:
transmitting, to the external device, the setting value set before the LTSSM operation is performed, in response to a read request for the register configuration, transmitted from the external device, during the LTSSM operation.

18. The method according to claim 15, further comprising:
performing a Link Training and Status State Machine (LTSSM) operation for performing data communication, in response to a link request according to an Active Link Management Protocol (ALMP) handshake, received from the external device.

19. The method according to claim 15, wherein updating the setting values comprises:
setting a register configuration corresponding to the interface version of the external device as a default value, in response to the first interface version of the external device, which is older than a version previously stored in the firmware binary; and
adding a register configuration, corresponding to the version previously stored in the firmware binary, in an extended area.

20. The method according to claim 19, further comprising storing the firmware binary in a non-volatile memory.
